(19) United States
(12) Patent Application Publication
(10) Pub. No.: US 2016/0296870 A1
(43) Pub. Date: Oct. 13, 2016

(54) VENT FILTER AND APPLIANCE UTILIZING SUCH A FILTER

(71) Applicant: Electrolux Home Products, Inc., Charlotte, NC (US)

(72) Inventors: Robert Rankin Mckechnie, IV, Concord, NC (US); Christopher A. Smith, Mt. Holly, NC (US); Manuel A. Chakarji, Charlotte, NC (US); Gregory E. Gault, Charlotte, NC (US)

(21) Appl. No.: 15/097,789

(22) Filed: Apr. 13, 2016

Related U.S. Application Data
(60) Provisional application No. 62/146,438, filed on Apr. 13, 2015.

(51) Int. Cl. B01D 46/00; F24C 15/20

(52) U.S. Cl. CPC B01D 46/0005; F24C 15/2035

(57) ABSTRACT

A vent filter for a cooking appliance is disclosed. The vent filter is user-replaceable once it has been spent or its filtration capacity consumed. In disclosed embodiments, the filter is provided in or as part of a cartridge that can be reversibly installed and removed from the appliance without tools. Retention structure is disclosed for holding the filter media in place in a filter receptacle communicating with or formed as part of the exhaust duct of the appliance for air to be filtered. In embodiments, the filter is configured as a recirculating filter to remove odor-causing contaminants, among other contaminants, from cooking fumes before the air from those fumes is recirculated into the kitchen or other ambient environment.

### CROSS REFERENCE TO RELATED APPLICATIONS

This application claims the benefit of U.S. Provisional Patent Application Ser. No. 62/146,438 filed Apr. 13, 2015, the contents of which are incorporated herein by reference.

### BACKGROUND

1.

Field of the Disclosure

The disclosed subject matter relates to filtration systems for appliances, and in particular to odor and particulate filters for cooking fumes.

2. Description of Related Art

It is known to provide recirculation filters above cooktops in order to filter out grease, odors and other particulates from cooking fumes emanating from the cooktop, prior to recirculating the air in the kitchen environment. Such filters are commonly found on over-the-range microwave ovens, which act as a fume hood above a cooktop. Such filters also can be provided in stand-alone vent hoods that do not vent to the outside, but rather into the kitchen. In either case a fan or blower draws cooking fumes and other vapors from the cooktop and through the filter before exhausting the drawn air. The grease filter traps grease and other particulates. Such filters also can include charcoal to remove odors from fumes generated during cooking, before being recirculated into the kitchen. When the filter is fitted to an over-the-range microwave, the filter also could be used to filter cooking fumes generated within the cooking cavity of the microwave oven.

Charcoal filters are designed to remove odors generally, but are not designed to remove specific chemicals or compounds from filtered air. Further, to operate properly, grease filters should be cleaned regularly and charcoal filters replaced regularly. Charcoal filters when used in this application also tend to be fairly thin, and therefore the absorptive capacity of the charcoal filters is small. Such filters may not be easily accessible and, thus, not regularly cleaned and/or replaced by the user.

Current recirculation filters on OTR applications include filter media designed to remove odor-producing agents generated on the cooktop before the air is recirculated back into the kitchen. However, current filters are minimally effective and users may not know that the filter can be replaced.

### SUMMARY OF THE INVENTION

A filter for a cooking appliance is provided. The filter includes a media block configured to at least partially remove from a stream of air passing therethrough chemical, particulate and/or odor-causing contaminants generated from cooking. The filter also includes and a facing element adhered to the media block. The facing element is configured to act as a flange to inhibit over-insertion of the media block into a filter receptacle or exhaust duct of an appliance.

A filter assembly for a cooking appliance is also provided. The assembly includes a filter cartridge dimensioned to house a media block and configured to be removably installed in a filter receptacle or exhaust duct of an appliance. The filter cartridge has a plurality of generally open side walls to permit air carrying contaminants to flow therethrough. A front side of the cartridge has an unobstructed opening through which the media block having substantially corresponding dimensions can be inserted.

A further filter assembly for a cooking appliance is provided. This assembly includes a media block and at least one reinforcing element attached to the media block. The reinforcing element has greater dimensional stability than the media block. Atleast one cutout is provided in the reinforcing element and is configured to receive a lance element therethrough.

A cooking appliance is also provided. The appliance has a ventilation system configured to draw cooking vapors and filter at least one of particulates and odor-causing species prior to recirculating air from the vapors back into the ambient environment. The ventilation system includes an exhaust duct for directing the air back into the environment, a filter receptacle communicating with or formed as part of the exhaust duct, and an opening through an exterior cabinet of the appliance through which the receptacle is accessible from outside the appliance. A covering member is configured to reversibly close and provide access to the opening without use of tools. The covering member has a geometric structure such that when used to close the opening the covering member presents a substantially continuous appearance with surrounding structure of the appliance.

### BRIEF DESCRIPTION OF THE DRAWINGS

FIG. 1 is a rear perspective view of an example filter as herein disclosed.

FIG. 2 is a side view of the filter in FIG. 1.

FIGS. 3a-3b illustrate installation of a filter as in FIG. 1 in a microwave appliance.

FIG. 4a shows a further embodiment, wherein an appliance includes a door for accessing a filter receptacle for installation of a filter.

FIG. 4b shows the embodiment of FIG. 4a, but with the door closed.

FIG. 5 illustrates a further embodiment of an appliance configured to receive a filter assembly for a recirculating filter.

FIG. 6 is a close-up view of the filter assembly that can be used in the appliance of FIG. 5.

FIG. 7a illustrates an articulated media block for a filter.

FIG. 7b illustrates a filter assembly wherein an articulated media block is attached to a facing member.

FIG. 7c illustrates an embodiment of a filter composed of a plurality of filter segments.

FIG. 8 shows a cartridge for a filter according to an embodiment.

FIG. 9 illustrates an embodiment similar to FIG. 4a, except that the filter receptacle 20 features keyways 21 to accommodate the filter cartridge shown in FIG. 8.

FIG. 10 illustrates a door for reversibly closing off and providing access to a filter receptacle in an appliance, according to an embodiment herein described.

FIG. 11 shows an embodiment of a filter media block having a reinforcing layer.

FIG. 12 shows a further embodiment of a filter media block having reinforcing strips.

FIG. 13 shows yet a further embodiment of a filter media block within a reinforcing cage.

FIGS. 14a-b illustrate schematic side views of a filter-ejection system for ejecting a filter from a filter receptacle within an appliance.

### DETAILED DESCRIPTION

The present subject matter will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation numerous specific details are set forth in order to provide a thorough understanding of the present subject matter. It will be evident, however, that the present subject matter can be practiced without these specific details. Additionally, other embodiments of the subject matter are possible and the subject matter is capable of being practiced and carried out in ways other than as described. The terminology and phraseology used in describing the subject matter is employed for the purpose of promoting an understanding of the subject matter and should not be taken as limiting.

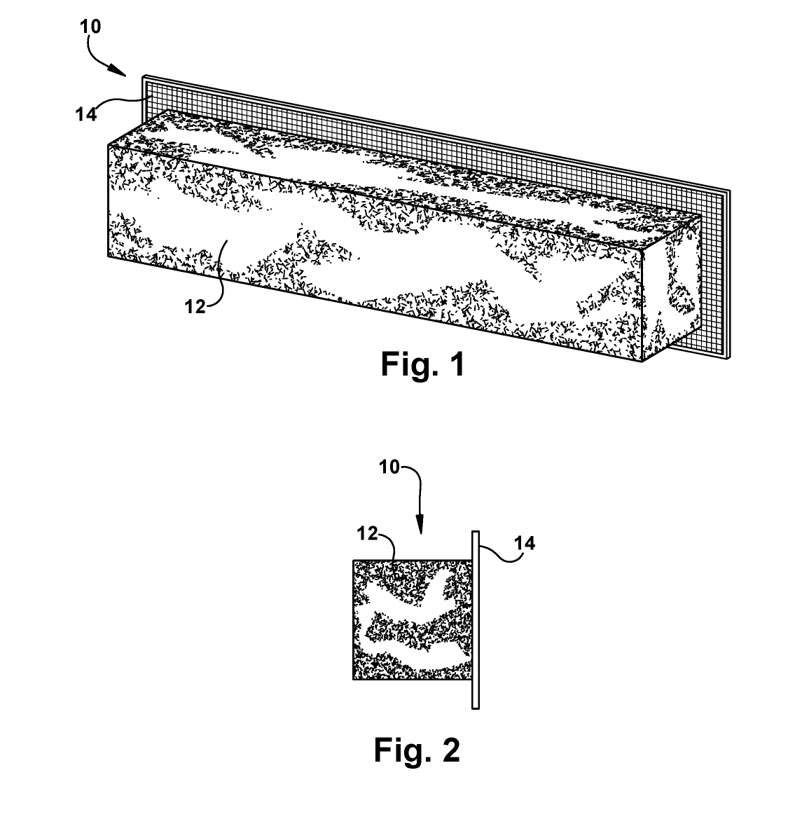

FIG. 1 shows an example filter 10 for use in an appliance, such as a microwave oven, free standing range, cooktop, vent hood, or other appliance (such as a room air condition, air purifier, etc.). In preferred embodiments, the appliance is a home cooking appliance and the filter is emplaced over a cooktop where it can be used to filter odors from cooktop fumes prior to the air from said fumes being recirculated into the kitchen or other ambient environment. For ease of explanation, the filter 10 will be discussed in the case of its installation in an over-the-range (“OTR”) microwave oven. But other implementations are contemplated, such as a fume hood and others as noted above.

In certain embodiments, the filter 10 is designed to be placed into an air duct or plenum within the OTR microwave oven, to filter an airflow within the duct before it is discharged from the microwave oven. The airflow can be a recirculating air flow drawn from the kitchen (e.g., above a cooktop), or it can be a discharge airflow from the cooking cavity of the microwave oven; or it can receive and filter air from both locations. In FIGS. 1 and 2, the filter 10 has a media block 12 and a face sheet 14. The face sheet 14 can be larger than the media block 12, allowing the face sheet to act as a flange for mounting the media block within an air duct.

The media block 12 can be any filter media providing suitable airflow and a degree of odor removal from the airflow. Example materials of construction for the media block 12 include polyester, fiberglass, foam, etc. In an embodiment, the media block 12 is formed from one or more flame-retardant, polyester, non-woven, fiber blocks, such as thermally-bonded, heat stable, densified polyester batting. The media block 12 can be treated to adsorb airborne contaminants, to thereby remove odors from an airflow. For example, the media block can be treated with one or more of carbon, zeolite, diatomite, molecular sieves, particle scavengers, and the like. The chemical composition of the odor-removal treatment applied or added to the media block 12 can be tailored to the specific compounds to be removed by the filter 10.

The face sheet 14 can be any material providing suitable airflow and, optionally, a final filtration stage. Example materials of construction for the face sheet include polyester, paper, or various fabrics. As shown in FIG. 1, the airflow passes through the media block 12 and then through the face sheet 14.

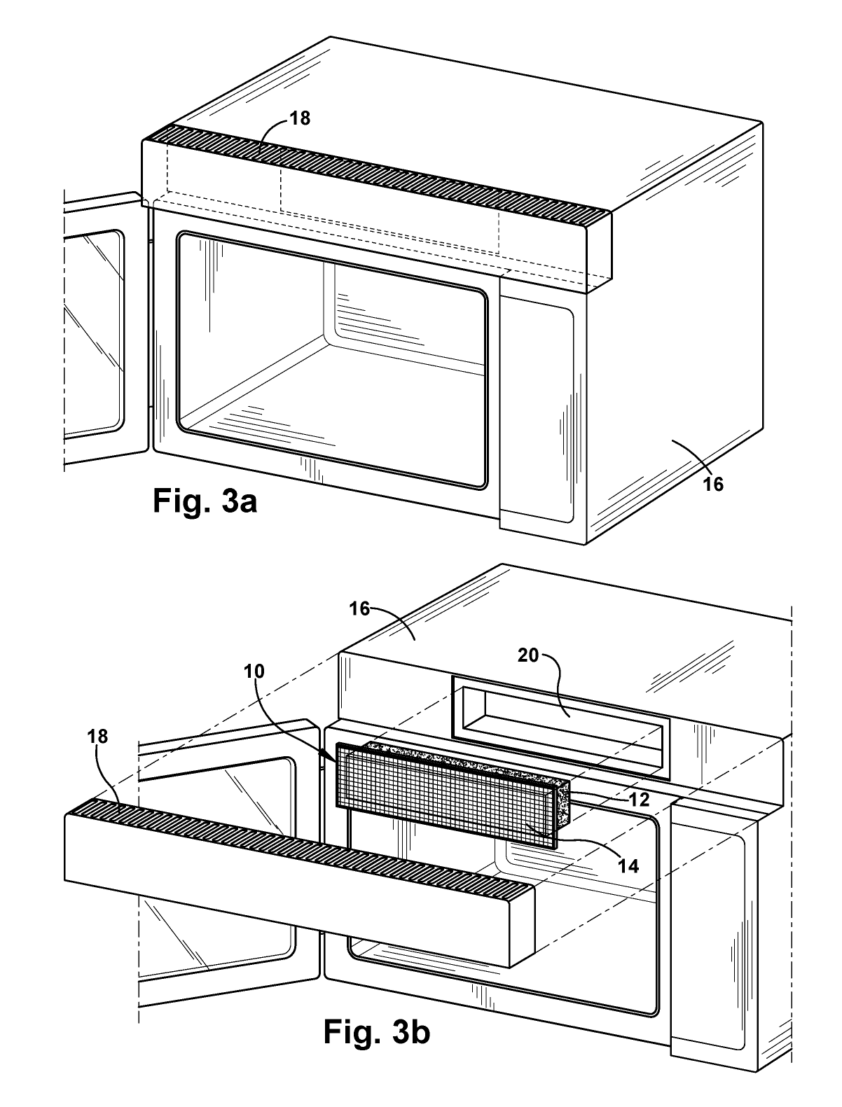

FIGS. 3a-3c show the use of a filter 10 in a retrofit application, in which the filter is applied to a previously-installed microwave oven 16. The microwave oven 16 exhausts air through an exhaust louver 18. The exhaust louver 18 can be configured to discharge air in various directions such as forward, upward, laterally, etc. To install the filter 10, the exhaust louver 18 is removed from the microwave oven 16 as seen in FIG. 3a, to expose a discharge end of the air duct. The media block 12 is sized to fit snuggly within the discharge end of the air duct. The face sheet 14 is larger than the discharge opening of the air duct. Thus, the face sheet acts as a flange that limits the insertion depth of the media block 12 within the air duct. After the filter 10 is inserted into the air duct as seen in FIGS. 3b, the louver is reinstalled on the microwave oven 16.

The face sheet 14 preferably is composed of a porous fabric or fibrous material presenting a low pressure drop to ensure that air flowing through the filter can exit substantially unimpeded. As noted above, optionally the flange itself can be configured as a final filtration stage, wherein openings or spacings between adjacent fibers or other elements forming the sheet 14 are sized to exclude particulates to be filtered. In a further alternative, the face sheet 14 fabric may be chemically impregnated or treated with species effective to adsorb chemical or odor-causing contaminants in the exhaust air before it is eluted. In a further alternative, the face sheet 14 can be made of plastic, metal or composite board that has been provided with sufficient openings to ensure superficial mass airflow therethrough with acceptable, e.g. minimal or negligible, pressure drop. In retrofit applications as described above, it may be necessary to remove external hardware from the appliance using tools (e.g. the louver 18 described above) to provide access to the exhaust duct for filter installation. In many cases, the duct may not have been designed to accommodate a filter at all, requiring the media block to be designed so that can fit into a duct originally not meant to receive one. In such applications, the function of the face sheet 14 to regulate insertion depth may be particularly relevant, both to ensure the media block 12 does not penetrate into the exhaust duct deep enough to interfere with other internal equipment, and to ensure that it does not become so recessed that it cannot be readily removed. In non-retrofit applications, however, where the appliance (e.g. microwave oven 16) has been designed to accommodate a user-replaceable filter (a ‘designed-in’ application), the appliance may be designed so that removal of external hardware is not required; or so that if required, such hardware can be removed and replaced readily by the consumer without the use of tools. In designed-in applications, the face sheet 14 described above may be less important, or if used it need not necessarily act as a flange that regulates insertion depth of the media block 12 in an exhaust duct.

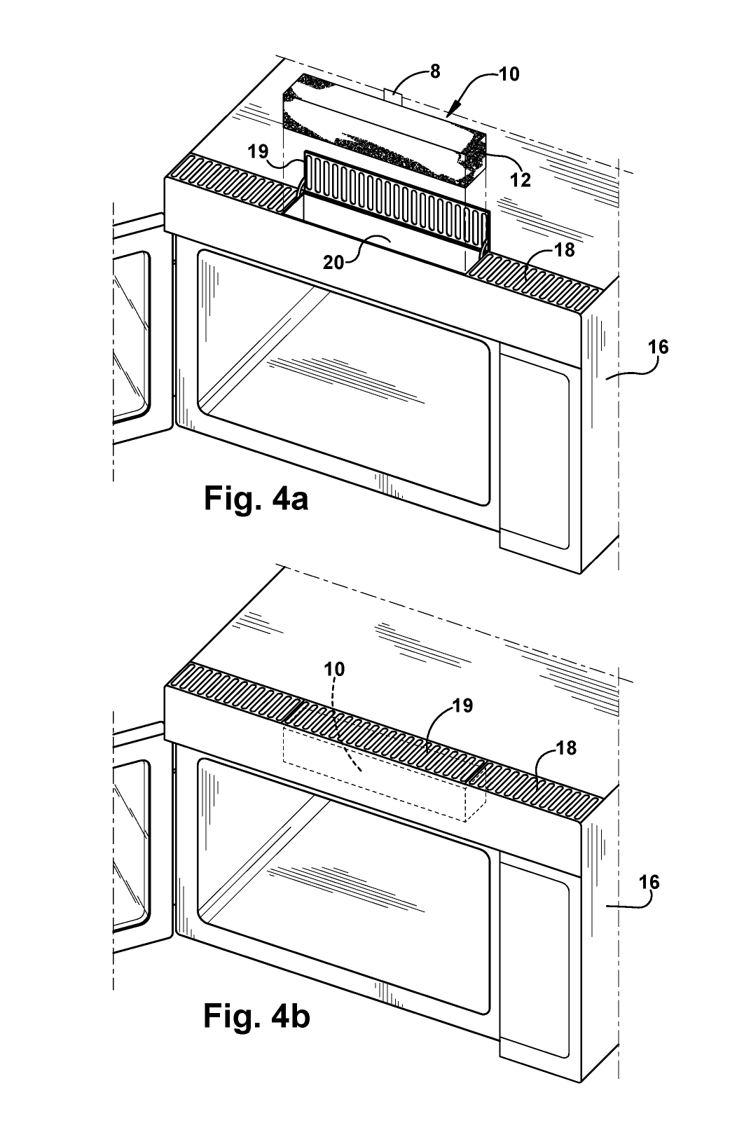

FIGS. 4a-b illustrate a further embodiment wherein a filter 10 is inserted into an appliance (in the illustrated embodiment, a microwave 16) configured to receive the filter 10. In FIGS. 4a-b, a door 19 is fitted onto the louver 18 or other external surface of the appliance, over a filter receptacle 20 that is configured to receive and accommodate the filter 10. The door 19 can be hinged to the appliance, e.g. as shown in FIGS. 4a-b. Alternatively, the door 19 can be configured to be snapped into place via resilient tabs fixed to the door 19 and cooperating with associated receptacles or detents within the appliance, or vice versa (not shown). Other suitable or conventional structure for reversibly opening (e.g. removing) and closing the door 19 could be readily selected and implemented by the person of skill in the art.

The door 19 closes an opening in the cabinet of the appliance (microwave 16) through which the filter 10 is inserted into the underlying receptacle 20. The receptacle 20 preferably comprises a portion of the exhaust duct for the appliance, through which air such as cooking fumes drawn via a fan (not shown) of the appliance is eluted. In preferred embodiments, the receptacle 20 constitutes a (or part of a) terminal portion of the exhaust duct so that air flowing through the duct must pass through an installed filter 10 to remove undesired contaminants prior to being eluted. The door 19 can be formed in, as part of, the exhaust louver 19 through which eluted air must pass on exiting the appliance. This is shown in FIGS. 4a-b. In this configuration, preferably the door 19 is formed having geometric structure rendering it substantially continuous in both function and form with the remainder of the louver 18 about the opening that is sealed via the door 19 when closed, as best seen in FIG. 4b. Alternatively, the door 19 can be disposed in another portion of the appliance cabinet; e.g. adjacent the exit louver 18. In such a case, the door 19 preferably again is configured so that it follows the form and geometry of the surrounding cabinet structure so as to be substantially continuous therewith in order to provide a substantially seamless, aesthetic appearance from the outside.

To install a filter 10 through the door 19, first the door is opened to provide access to the underlying receptacle 20 as seen in FIG. 4a. If there is already a filter present in the receptacle 20, then it is removed, e.g. by grasping and pulling an attached tab 8. The used filter can be discarded. Alternatively, if the used filter is made of a material that can be cleaned, as by washing in the dishwasher and reused, then it may be so cleaned and saved for the next filter change. The new filter 10 is inserted into the empty receptacle 20 via the exposed opening normally closed by the door 19, until it is seated therein. The filter 10 may be seated fully against a floor of the receptacle 20, e.g. in case the exhaust duct meets the receptacle 20 from a lateral direction. Alternatively, if the duct approaching the receptacle 20 is coaxial therewith, e.g. if the louver in FIGS. 4a-b faced forward rather than upward and the door therefore were in the front face of the appliance, then a ledge or flange may be provided within the duct at the depth corresponding to the insertion depth of the filter 10, thereby partially defining the receptacle 20 in order to seat the filter 10 therein. Once the filter 10 is fully inserted within the receptacle 20, the door 19 is closed as seen in FIG. 4b and the appliance is ready to be operated to filter exhaust air via the newly installed filter 10. Once that filter 10 becomes saturated or otherwise spent, it can be replaced in a similar manner as above.

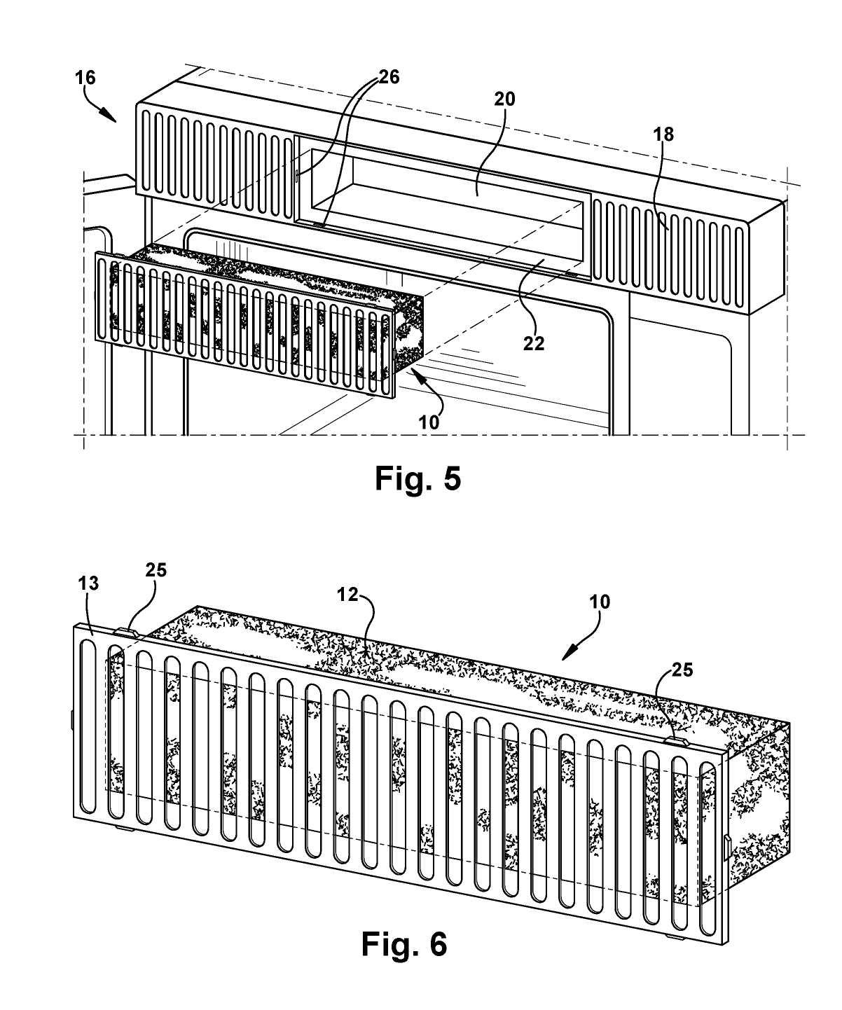

FIG. 5 illustrates a further embodiment of an appliance (again, a microwave 16 is illustrated) configured to receive a filter 10 for filtering exhaust air prior to elution. In this embodiment the filter receptacle 20 again is provided at or as part of a terminal portion of the exhaust duct through which air to be filtered travels on its way to being eluted. Here, there is no door closing the opening that exposes the receptacle 20. Instead, the filter 10 is configured as a filter assembly having a media block 12 secured to a facing member 13 (best seen in FIG. 6). Like the door 19 in the preceding embodiment, here the facing member 13 is formed having geometric structure rendering it substantially continuous in both function and form with the remainder of the louver 18 about the opening through which the filter 10 is inserted. That is, the facing member 13 itself forms a part of the louver 18 through which exhausted and filtered air is eluted from the appliance, after passing through the media block 12. When installed, from the outside the facing member 13 provides a substantially continuous, seamless appearance with the surrounding structure of the appliance's cabinet; in the illustrated embodiment, with louver 18. Alternatively, the opening through which the assembly is inserted can be disposed in another portion of the appliance cabinet; e.g., adjacent the exit louver 18. In such a case, the facing member 13 preferably again is configured so that it follows the form and geometry of the surrounding cabinet structure so as to be substantially continuous therewith in order to provide a seamless, aesthetic appearance from the outside.

Still referring to FIG. 5, in preferred embodiments the media block 12 has a somewhat smaller cross-section than the facing member 13. The opening for the filter receptacle 20 is surrounded by a lip or flange 22 against which the facing member 13 is seated when fully inserted. Preferably the media block 12 has cross-sectional shape and dimensions corresponding to the opening of the receptacle 20 defined and bounded by the flange 22, so that as the media block 12 is inserted into that receptacle the facing member 13 becomes closer to and eventually seated against the flange 22. In this embodiment the facing member 13 itself can act as a flange to help define the insertion depth of the media block 12, thus rendering additional internal structure for doing so superfluous. Optionally, the facing member 13 can incorporate additional structure to reversibly retain it in place on the appliance and against the flange 22. For example, one or a plurality of embossments 25 may be provided along the exterior, lateral edge(s) of the facing member 13, which will cooperate with and be retained within corresponding and complementary recesses or detents 26 in the appliance cabinet to retain the filter assembly in place. To remove that assembly, one need simply deflect the lateral edge(s) of the facing member 13 just enough to unseat the tab(s) and remove the assembly. Alternatively, a simple interference fit between the facing member 13 and the seat therefor in the appliance cabinet can be relied on to retain the assembly, so long as the interference fit is sufficiently robust to withstand ejection of the assembly via exhaust-gas pressure in use. As a further alternative, a latch or other conventional locking structure may be utilized to retain the assembly in place in use.

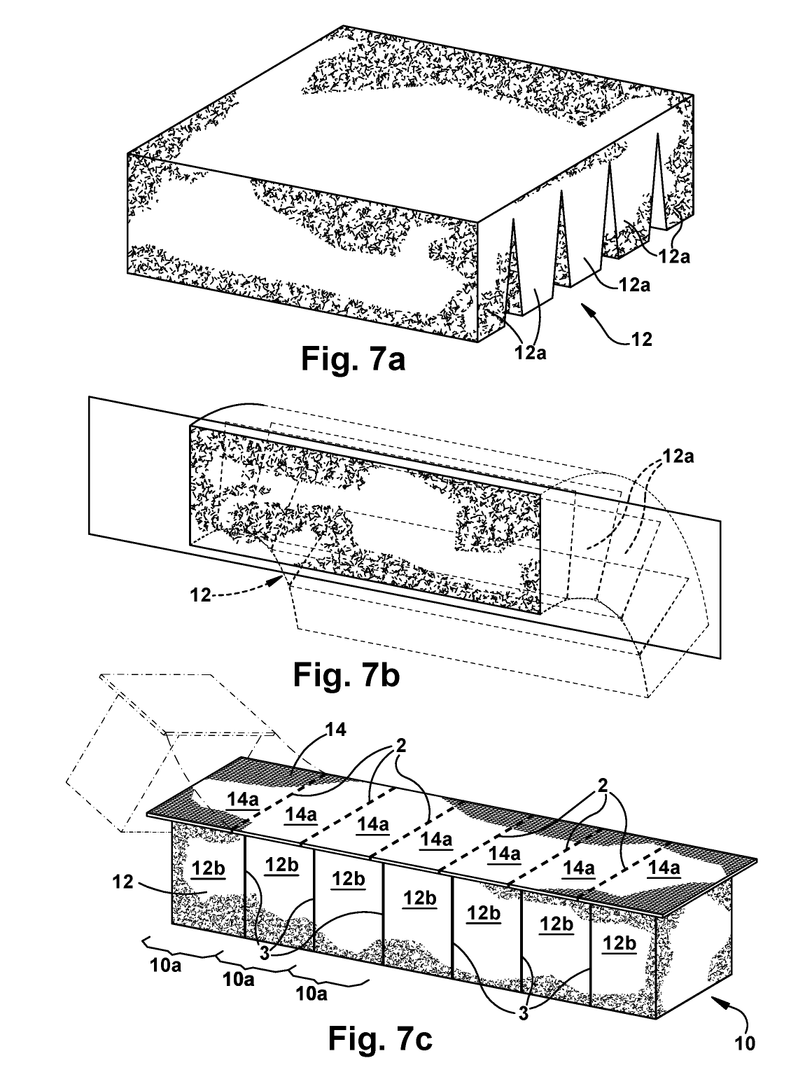

In certain applications it may be desired that the media block 12 will extend some depth into the exhaust duct. For example, the deeper into the duct the block 12 extends, the greater filter medium is available to remove contaminants. Larger-sized medium translates into greater filter capacity, which in-turn may translate into longer change-out intervals and/or better filtration of odor-causing species. However, insertion depth for the media block 12 may be limited by the depth of available exhaust duct that remains straight and linear. FIGS. 7a-b illustrate further embodiments of a filter (FIG. 7a) or filter assembly (FIG. 7b) as discussed above, wherein a long filter block configured to be inserted to a more substantial depth within an exhaust duct is articulated via lateral cut-outs distributed along its length. In the illustrated embodiments, the lateral cutouts are triangular in shape, producing articulated segments 12a that are trapezoidal in cross-section. However, the cutouts and articulated segments can readily have alternative shapes; e.g. rectangular. As will be appreciated, an articulated media block 12 as here described can be inserted into an exhaust duct that bends around one or more axes parallel to the lateral extent of the articulated segments 12a. As it is inserted, the segments can articulate so that the media block 12 will follow and conform to the contour of the duct as it is inserted. Such a media block 12 can be configured as a stand-alone filter 10, e.g. insertable via a door that can be opened to give access to a filter receptacle 20 in an appliance as above described. Alternatively, it can be attached to a facing member 13 to form a filter assembly as also above described.

In a further embodiment, the filter 10 can be provided having an adjustable width in order to fit within exhaust ducts of a variety of different appliances, particularly in retrofit applications. For example, as seen in FIG. 7c a filter 10 having a media block 12 attached to a face sheet 14 can be composed of a plurality of laterally distributed filter segments 10a. Each segment 10a includes a face-sheet segment 14a and a media segment 12b attached to one another. The face sheet 14 in this embodiment can be similar as above described, and preferably includes score marks 2 between adjacent face-sheet segments 14a. Similarly, the media block 12 includes scoring or cuts 3 between adjacent media segments 12a. Preferably, the score marks 2 are substantially aligned with the cuts 3, preferably substantially coplanar therewith. The cuts 3 can be simple score marks over the surface of the media block 12 providing areas of weakness and to indicate to a consumer locations where (s)he can cut the block 12 to produce a desired, graduated width (e.g. with a utility knife). Alternatively, the cuts 3 can be completely through the block 12 at graduated lateral locations so that filter segmets 10a can be readily separated from the filter 10 upon separating the associated face-sheet segment 14a from the rest of the face sheet 14. This embodiment recognizes that exhaust duct height, while not necessary standardized across appliances from different manufacturers, may nonetheless be essentially uniform for certain types of appliances, within a modest tolerance that can be accommodated by the compressive-elastic properties of media-block materials. However, exhaust-duct width may tend to vary widely. Thus the present embodiment is useful to provide a universal aftermarket filter 10 that can be cut to size laterally to approximate the size of a particular exhaust duct where the filter 10 will be installed. That is, the consumer could hold the filter 10 up to the duct where it is to be inserted, and then break off sufficient filter segments 10a to leave a filter 10 that is approximately (if not slightly wider than) the width of the exhaust duct. The resulting filter 10 can then be inserted, with some modest compression thereof if warranted to ensure a fit, and the detatched filter segments 14a discarded.

Returning briefly to FIGS. 4a-b, that embodiment contemplates insertion of a filter 10 composed primarily of a media block 12; e.g. fiber batt formed into a block, which can be impregnated with adsorptive species. However, such a media block 12 may be highly flexible and have low dimensional integrity, which could make insertion and maintenance of its overall form within the filter receptacle 20 challenging. If the media block 12 were to become deflected during use that may expose a portion of the exhaust duct directly to the outside without any intervening filter medium at all, which will diminish filter performance.

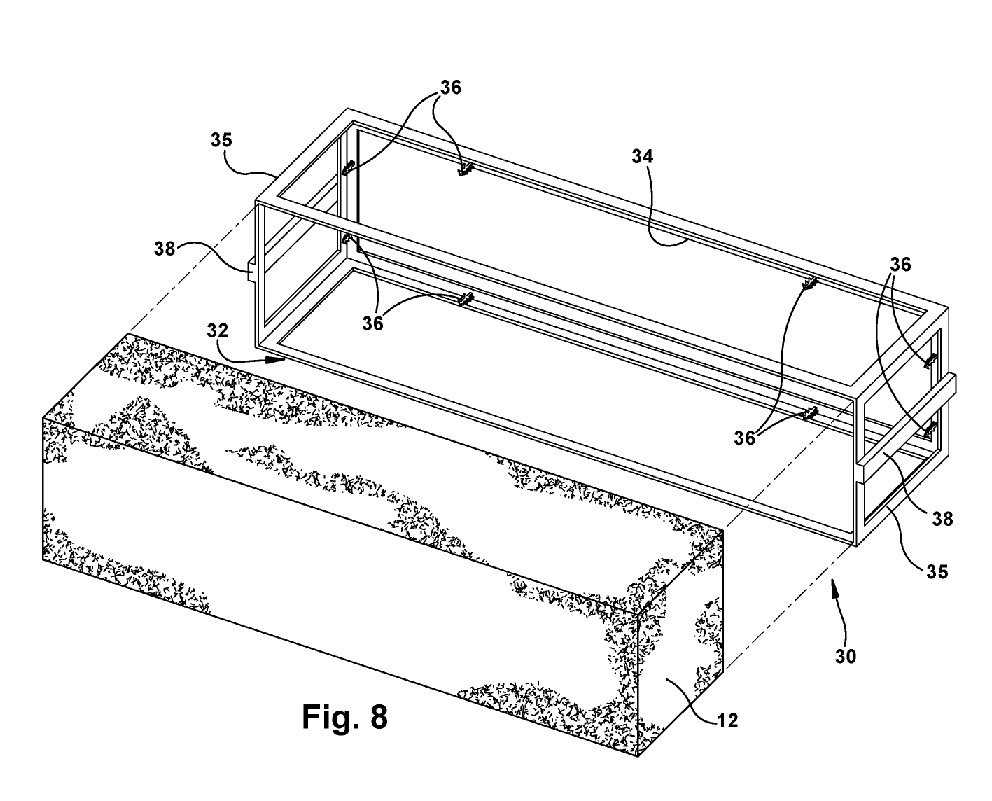

FIG. 8 illustrates a cartridge 30 configured as a cage that is dimensioned to house a media block 12 therein. Preferably the media block 12 used with this cartridge will have a shape and dimensions corresponding to the interior space defined within the cartridge 30. The cartridge 30 has generally open side walls. A front side of the cartridge constitutes an unobstructed opening 32 through which a media block 12 having substantially corresponding cross-sectional dimensions can be inserted. The interior rear wall 34 of the cartridge 30 is composed of a perimeter flange against which the rear face of a media block 12 would rest upon complete insertion. A series of lances, which may be configured as barbs 36, extend forward from the rear wall 34 toward the front opening 32. As the media block 12 is inserted, the barbs 36 penetrate and retain the block 12 within the cartridge 30. These barbs 36 can be in a number of shapes and can be located at any points around the rear wall 34. In the illustrated embodiment, the barbs have a ‘Christmas tree’ configuration, but other configurations are possible and could be selected by one of ordinary skill in the art. As well be appreciated, lances having other configurations, e.g. those without hook or locking features, could also be used to register and help retain the media block 12.

The cartridge 30, with media block 12 installed, can be inserted into the filter receptacle 20 of an appliance, e.g. via an opening exposed by opening a door 19 as seen in FIG. 4a. The cartridge 30 provides dimensional and structural support to the media block while it is being inserted and removed to/from the receptacle 20, and also in use so that the current of exhaust air is less likely to deflect it or flow around it.

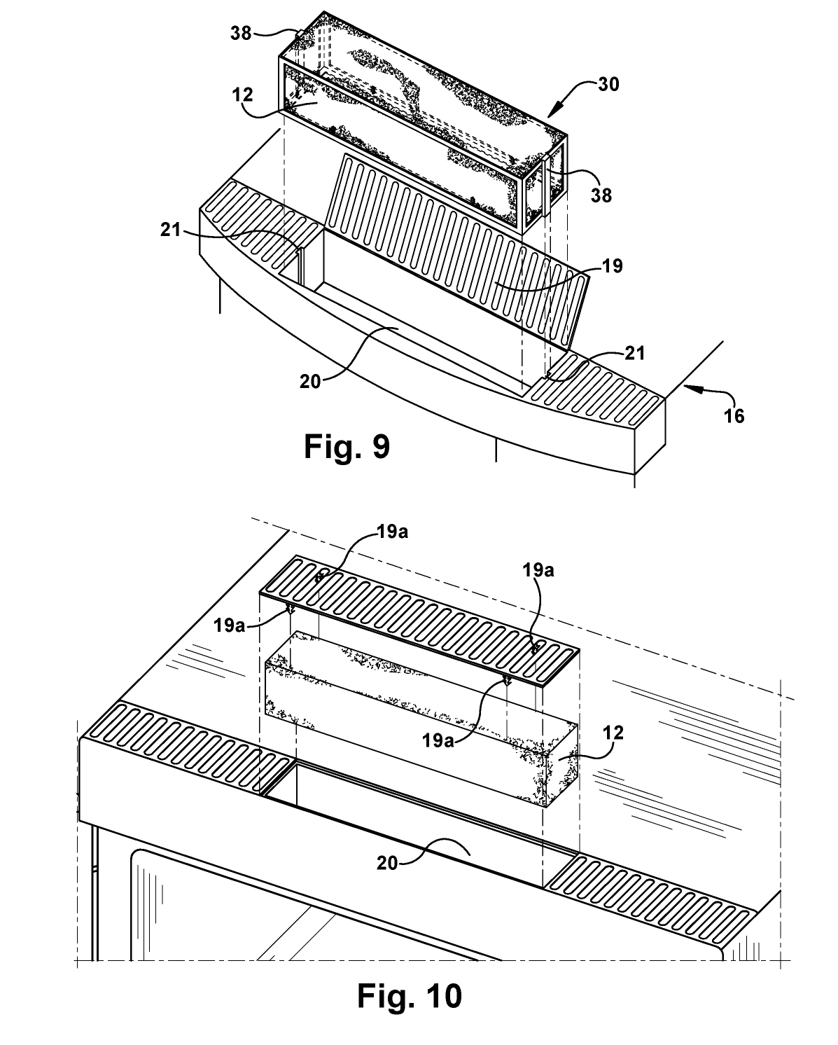

FIG. 9 shows a close-up view of an appliance having a filter receptacle 20 and door 19 similar to FIG. 4a, except that the receptacle 20 walls feature keyways 21. The filter cartridge illustrated in FIG. 8 has corresponding keyed elements 38 extending longitudinally along the outer side walls 35 thereof. The keyed elements 38 and keyways have complementary cross-sectional geometries so that as the cartridge 30 is inserted into the filter receptacle 20 its alignment and orientation are fixed relative to the receptacle 20. The keyways 21 and keyed elements 38 are illustrated having simple rectangular geometries. But any other cross-section that can be provided and maintained in extruded form can be utilized; so long as aligned and complementary keyed elements 38 are received and guided within the keyways 21 upon insertion of the cartridge 30. Once the cartridge 30 is fully inserted and seated, the door 19 can be closed thereover similarly as in the embodiment of FIGS. 4a-b discussed above.

The cartridge 30 may be reusable; for example it may come with the appliance having a media block 12 pre-installed. To replace the media block 12 once spent, the door 19 would be opened, the cartridge 30 removed from the receptacle 20 and the spent media block 12 replaced with a fresh or cleaned one. Then the cartridge 30 could be re-installed as above. Alternatively, the cartridge can be disposable. For example, replaceable cartridges having media blocks pre-installed can be sold or provided separately as a complete assembly for installation in the filter receptacle 20 of the appliance. Such disposable filter cartridges 30 can have keyed elements 38 to mate with corresponding keyways 21 similarly as in the preceding embodiment. When the enclosed media block 12 becomes spent, the entire filter-cartridge assembly can be removed, discarded and replaced with a fresh one. In the latter embodiment, lances (e.g. barbs 36) as described above may be of less use because the consumer need not remove and replace the enclosed media block 12. Instead, for example, the cartridge 30 can have a front perimeter flange (similar to that at rear wall 34 in FIG. 8) in place of the front opening 32 in FIG. 8 to retain the media block 12 therein.

FIG. 10 illustrates another embodiment wherein instead of a hinged door as seen in the embodiment of FIG. 9, the door 19 is removable and can be retained in-place in the appliance via, e.g., resilient tabs 19a. As in other embodiments, the door 19 possesses geometric structure that is substantially continuous with the structure of the appliance cabinet, e.g. louver 18, surrounding the opening where the door is emplaced. In this embodiment, however, the inside surface of the door 19 contains a series of lances (e.g. barbs 36) similar to those described above, effective to retain a filter media block 12 thereon. In this embodiment, the media block 12 is installed directly to the door 19, whereupon the resulting assembly is installed such that as the door 19 is replaced over filter receptacle 20 in the appliance, the media block 12 fitted thereto becomes inserted and retained within that receptacle. In this embodiment, depth of insertion is fixed based on the depth of the block 12 and the fact that the door 19 itself serves as a flange that limits further insertion. To remove the media block 12, e.g. for replacement, the door 19 is simply removed and the media block 12 will be retained thereto via the barbs 36. Once uninstalled from the appliance, the door 19 and media block 12 can be physically separated by a consumer, and a fresh media block 12 installed for reassembly to the appliance.

Alternatively, the door 19 can be configured as a drawer having an attached receiver for holding a filter 10. The facing portion of the door acts as a facing member for forming the continuous exterior appearance to the appliance, and the attached receiver constitutes a drawer portion that slides into and out from the filter receptacle 20. In this embodiment, the door 19 is translated away from the appliance until the facing portion is remote from the cabinet and the receiver is substantially exposed outside of the receptacle 20. Then a filter 10 can be inserted into the receiver and the door 19 translated back toward the appliance until the receiver and contained filter 10 are re-introduced into the receptacle 20 for use. When the filter becomes spent, a similar operation can be carried out to replace the spent filter.

In the latter embodiments, the lack of structural integrity and dimensional instability of a conventional media block 12 typically might present an obstacle to securement of the block 12 to the door 19. For example, it may be difficult to press the media block 12 against barbs 36 so that they penetrate a depth into the block 12, rather than simply crushing the block 12 against them. Or when simply seated within a drawer receptacle as in the most recent embodiment, dimensional instability of the media block 12 could result in deflection thereof due to air currents, which can reduce filtration efficacy. Accordingly, structure that will impart additional mechanical robustness to the media block 12 may be desired.

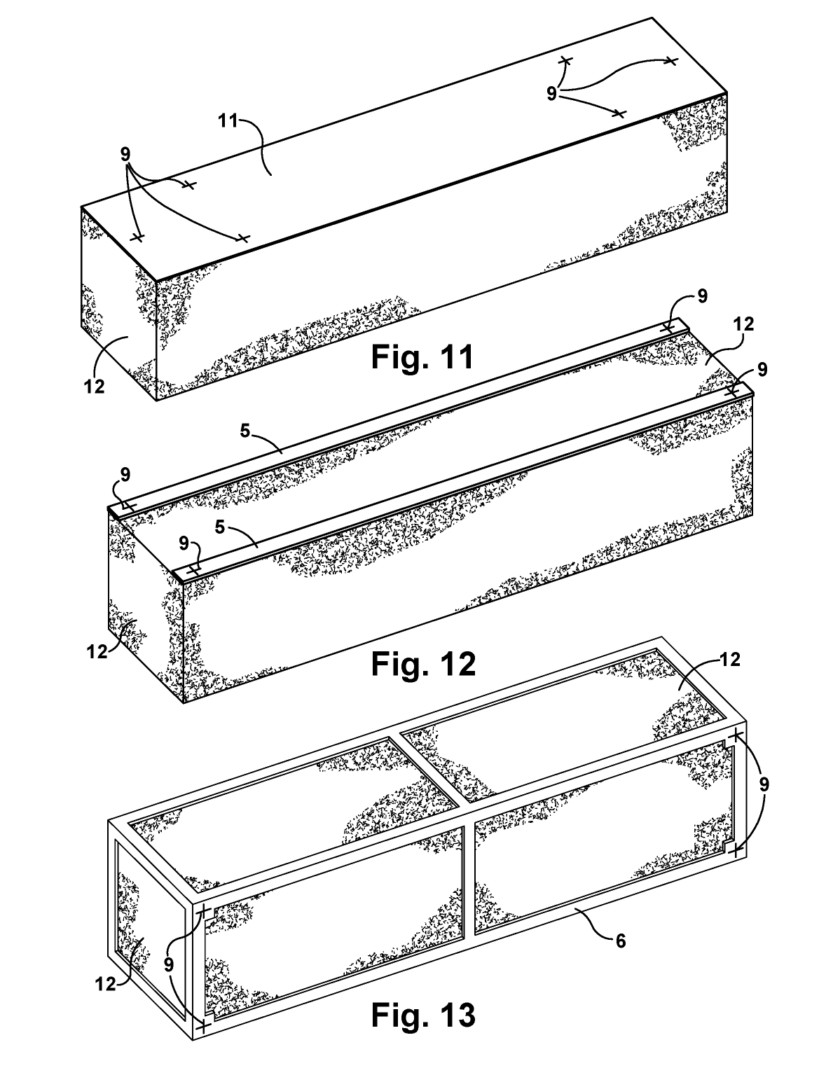

FIG. 11 shows an example filter media block 12 according to a further embodiment, in which a reinforcing cover layer 11 is laminated to the block 12. The reinforcing cover layer 11 preferably is composed of a porous fabric having greater dimensional integrity than the media block 12. The cover layer 11 can be provided with a plurality of score marks or cutouts 9 corresponding to locations where lances such as barbs 36 extend from the inner surface of door 19 shown in FIG. 10. In this embodiment, the media block 12 can be more easily assembled to the door 19 because the cover layer 11 will provide additional integrity to the surface where lances or barbs 36 (which may be present either directly on a facing element or in a receiver of a drawer-style door 19) must penetrate the block. A user can grasp an edge of that layer adjacent to the associated barb location and pull it against the barb until the barb 36 penetrates completely through the associated cutout 9. A porous fabric cover layer 11 will present minimal pressure-drop against which the exhaust air must be forced to elute from the appliance. Indeed, the cover layer 11 itself may be configured to provide a final filtration stage (e.g. having pore dimensions that will exclude certain-sized particulates) as previously described.

Alternatives to the cover layer 9 shown in FIG. 11 are illustrated in FIGS. 12 and 13. FIG. 12 illustrates a further embodiment wherein a filter media block 12 has reinforcing strips 5 of dimensionally robust material, more rigid than the media block 12, adhered to at least one face thereof, e.g. via adhesive. The reinforcing strips 5 can be made of, e.g., cardboard, reinforced paper, plastic, resin or even metal, and can be provided with a series of cutouts 9 similarly as in the previous embodiment. Alternatively, the reinforcing strips 5 can be made from denser media compared to that of the media block 12; e.g. dense fiber batt strips. These cutouts 9 again correspond in number and location to barbs 36 or other lances present on the door 19 as seen in FIG. 10, and provide robust support for securing and retaining the media block 12 to the door 19 via the barbs. Although the reinforcing strips 5 are illustrated running along the long edges of the face of the filter media block 12 in FIG. 12, reinforcing strips 5 could instead be provided running along the short edges; or alternatively along all four edges such that the reinforcing strips 5 form a rectangular window adjacent the edges of a face of the media block 12.

In the embodiment illustrated in FIG. 13 the media block 12 is disposed within a reinforcing cage 6 having cutouts 9 similar as above at strategic locations. In this embodiment the reinforcing cage 6 substantially encloses the media block 12, having corner edges located at and substantially corresponding to each of the edges of the filter media block 12. Additional cross members can also be provided to import additional dimensional rigidity and robustness. The cage 6 can be made of similar materials as noted above; e.g. reinforced paper, cardboard, plastic and/or metal. In this embodiment, it will be simple for a user to grasp the media-block assembly by the cage 6 and to press it against the door 19 with its cutouts 9 aligned with the lances or barbs 36 extending from the door. Once assembled to the door, the complete assembly can be installed to the appliance as already described, wherein as the door 19 is seated the caged filter media block 12 penetrates into and is seated within the underlying filter receptacle 20.

The filter embodiments illustrated in FIGS. 10-13 and discussed above have been described with respect to securing them to a removable door 19 that encloses a filter receptacle 20 within the appliance. However, it will be appreciated that similar dimensional robustness imparted to filters in these embodiments also can provide benefits when the filter is to be secured to alternative structure. For example, a structurally reinforced filter media block 12 according to any of the foregoing embodiments could be installed to a removable filter cartridge 30 as described above and illustrated in FIG. 8. Alternatively, other structure associated with the appliance and configured to secure a filter in place during use could be utilized with a structurally reinforced filter according to one of the foregoing embodiments.

Returning now to FIG. 4a, as noted above in this embodiment once the door 19 has been opened to expose the underlying filter receptacle 20, a filter 10 already in-place can be removed therefrom, e.g. via a tab 8 attached to the filter 10. However, in instances where it is undesirable or difficult to attach such a tab 8 to the filter, alternative mechanism to facilitate ejection of the filter 10 can be used. This may be helpful, for example, in cases when the filter 10 consists only of a fiber batt, to which it may be difficult to adhere a tab that would not be torn away, or which would not tear away part of the fiber batt when tugged.

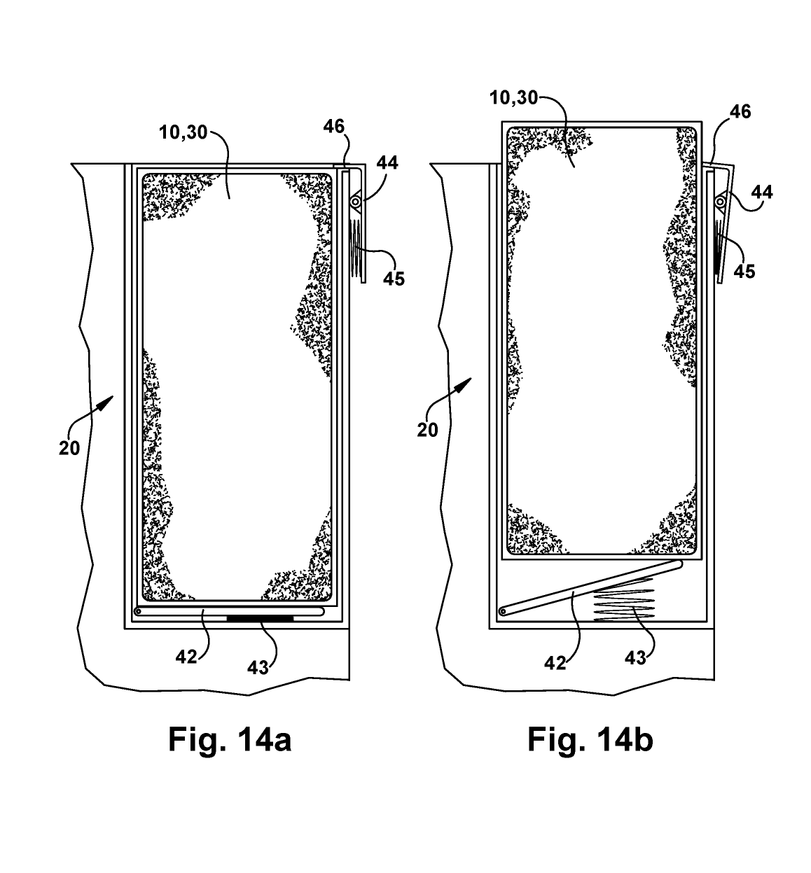

FIGS. 14a-b schematically illustrate a filter-ejection system that can be utilized to eject a filter 10 (or filter cartridge 30) from the filter receptacle 20. The system includes an ejector 42 disposed within and at the base of the filter receptacle 20. In the illustrated embodiment, the ejector 42 is configured as a lever that is spring biased upward (i.e. toward the opening of the receptacle 20) via spring 43. A retainer 44 is provided at or adjacent that opening and is configured to retain a filter 10 (or cartridge 30) within the receptacle 20 against the biasing action of the ejector 42. In the illustrated embodiment, the retainer 44 is biased via spring 45 such that a tab 46 attached or formed therewith extends over the opening to the receptacle 20 and presents an obstacle to the ejection of the filter/cartridge 10/30 therefrom.

To install a filter/cartridge 10/30, the retainer 44 can be forced against the action of its biasing spring 45 to remove the tab 46 from the path of the opening. In this position, the filter/cartridge can be inserted through that opening into the filter receptacle 20. Thereafter, the retainer 44 is released and the filter/cartridge is pressed into the receptacle 20, in the direction of the arrow as seen in FIG. 14a, until it engages and presses the ejector 42 against the biasing action of its associated spring 42. The filter/cartridge is pressed in this manner until the terminal portion thereof clears the tab 46 of the retainer 44, such that the tab 46 snaps back into position over the opening 20 where it is effective to retain the filter/cartridge in place against the action of the ejector 42 as seen in FIG. 14b. To remove the filter/cartridge, the retainer 44 is again depressed against the action of spring 45 to displace the tab 46 out of the path of the filter/cartridge, whereupon the biasing force of the ejector 42 will eject the filter/cartridge from the receptacle 20 enough for a user to grasp and remove it. The foregoing retention system therefore functions as a ‘push-and-release’ system for the filter or cartridge.

The present improvements relate to a revised vent filter and retaining system that provides improved performance and allows the consumer to readily replace the filter after its effective life has been exhausted. In general, air flows through a low density, preferably non-woven fiber media block 12 of the filter. The fiber block may be impregnated with one or more odor-removing agents, including one or more agents tailored to adsorb select contaminants, such as specific odor-causing agents.

In disclosed embodiments the filter block 12, cartridge 30 and features for retaining them together (e.g. barbs 36) can be in the form of a self-supporting, integrated cartridge with keyed elements 38 such as rails along the sides for insertion into the vent assembly via cooperating keyways 21.

In these embodiments, a piece of vent trim on the microwave, hood or other OTR or other appliance can be removed (either completely or swung out of the way as a door 19 via hinges) to provide access to a filter receptacle for insertion of the cartridge 30 with the filter media block 12 installed. In further embodiments, the filter can be provided in the form of an assembly having a facing member 13 carrying the filter media block 12, wherein the facing member can have a surface that is continuous with external features (e.g. aesthetic features or louvers) of the microwave, hood or other appliance, such that when the filter assembly is installed so that the media block 12 is inserted into the receptacle 20, the surface of facing member 13 serves as the exterior/top vent trim surface continuous with the surrounding features.

In further embodiments, a filter media block 12 can include a reinforcing cover layer 11 laminated, glued, or otherwise adhered to the fibrous matrix of the filter media block 12. The cover layer 11 has greater integrity and may be denser than the fibrous matrix, and generally will conform to the shape of the surface of the fibrous media block 12 to which it is adhered. In other embodiments, one or more relatively dense or rigid strips 5 (e.g. of cardboard or paperboard) can be adhered to one or more faces of the fibrous matrix, or provided in the form of a cage 6 enclosing the matrix. In each of these embodiments, prepositioned penetrations, score marks, cutouts 9 or other areas of weakness can be provided corresponding to the locations of cooperating lances, e.g. barbs 36, tabs or other retention structure in the cartridge in which the filter media block 12 is to be installed during use.

As will be appreciated, in a broad aspect the present improvements contemplate a filter or filter assembly wherein a media block is attached or attachable to a facing element. The facing element can be or include a face sheet that can act as a flange to inhibit over-insertion of the media block into a filter receptacle, but need not necessary act as a flange. The facing element also can be a facing member or a door for closing an opening into the filter receptacle of an appliance when installed. The facing member (e.g. door) can have structure that renders it substantially continuous in appearance and function with surrounding features of the appliance when installed over the opening of the filter receptacle. When configured as a facing member, the facing element can include lances, such as barbs, that penetrate the media block to facilitate alignment and retention of the media block to the facing member. The lances can pass through cutouts in a reinforcing layer or other reinforcing structure, e.g. strips or cage elements as above described, on their way to penetrating the media block if that block is equipped with such reinforcing structure. These and other features disclosed herein may be combined, such that individual embodiments herein described are not limited from being combined with features disclosed in connection with other embodiments.

A filter 10 in example embodiments is used to filter odors from cooking fumes prior to the air from those fumes being exhausted into a kitchen or other environment. When used above a cooktop, for example, such cooking fumes in addition to odor agents also may include grease and particulates that it also would be desirable to remove prior to exhausting to the environment. To this end, a filter 10 as herein described can be provided in an exhaust pathway of an OTR appliance, e.g. OTR microwave or vent hood, preferably downstream from a grease and/or solid particulate filter or ‘grease trap.’ Typically, a grease trap is located directly above the cooktop at the entrance to the exhaust pathway, before reaching the blower. This is so that grease entrained within cooking fumes, which otherwise may foul downstream components and ducting, can be trapped and removed from the airflow prior to entering the exhaust duct. Conventional grease traps are well known, and comprise, e.g., a metallic wire mesh that permits the passage of air but inhibits the passage of larger entrainments, such as grease droplets. Such a trap also can be configured to trap particulates of varying size depending on the breadth of openings therethrough.

In such embodiments, the exhaust duct (including an incorporated blower for drawing air) extends from the exit side of the grease trap at the underside of the OTR appliance, up through the appliance typically to an exit at an upper region of the appliance. In the illustrated embodiments here, a filter 10 is installed adjacent the exit of the exhaust duct at the upper portion of the associated appliance; e.g. OTR microwave 16. However, a filter 10 as herein described can be installed anywhere along the exhaust pathway in the appliance, although preferably it is installed downstream from the grease trap so that entrained grease does not foul the filter media block 12. For example, a filter receptacle 20 and associated cover element (e.g. door 19) can be provided at a lower portion of the OTR appliance, just above the grease trap. This position still would ensure cooking fumes encounter the grease trap prior to entering the filter 10. Alternatively, the filter receptacle 20 can be located at any other position on the appliance that is both accessible by a consumer from the outside (e.g. via opening or removal of a door 19) and is in the exhaust flow path.

Illustrative embodiments have been described, hereinabove. It will be apparent to those skilled in the art that the above apparatuses and methods may incorporate changes and modifications without departing from the scope of this disclosure. The invention is therefore not limited to particular details of this disclosure, and encompasses all such changes and modifications within the spirit and the scope of the appended claims.

What is claimed is:

1. A filter for a cooking appliance, said filter comprising a media block configured to at least partially remove from a stream of air passing therethrough chemical, particulate and/or odor-causing contaminants generated from cooking, and a facing element adhered to said media block, said facing element configured to act as a flange to inhibit over-insertion of the media block into a filter receptacle or exhaust duct of an appliance.

2. The filter of claim 1, said media block comprising a fibrous batting that has been impregnated with species effective to adsorb select odor-causing contaminants from a flowing air stream.

3. The filter of claim 2, said facing element comprising a porous face sheet that functions as a final filtration stage.

4. The filter of claim 1, said facing element being a facing member having geometric structure such that upon insertion of said media block into a filter receptacle or exhaust duct of an appliance, the facing member presents a substantially continuous appearance with surrounding structure of the appliance.

5. The filter of claim 4, said facing member comprising at least one lance element extending from an inner surface thereof, said lance element being received within said media block.

6. The filter of claim 5, said lance element being a barb that helps retain said media block together with said facing member.

7. The filter of claim 5, further comprising a reinforcing cover layer laminated to said media block, said cover layer having greater dimensional integrity than said media block and comprising at least one cutout through which said lance element penetrates the media block.

8. The filter of claim 5, further comprising at least one reinforcing strip adhered to said media block, said reinforcing strip having greater rigidity than said media block and comprising at least one cutout through which said lance element penetrates the media block.

9. The filter of claim 5, further comprising a reinforcing cage substantially enclosing said media block, said cage comprising at least one cutout through which said lance element penetrates the media block.

10. The filter of claim 1, said media block being articulated via lateral cut-outs distributed along its length.

11. The filter of claim 1, said facing element comprising a plurality of score marks distributed therein, said media block comprising a plurality of cuts associated with respective ones of said score marks, thereby dividing said filter into filter segments, wherein a width of said filter can be adjusted by separating therefrom one or a plurality of said filter segments.

12. A filter assembly for a cooking appliance, said filter assembly comprising a filter cartridge dimensioned to house a media block and configured to be removably installed in a filter receptacle or exhaust duct of an appliance, said filter cartridge having a plurality of generally open side walls to permit air carrying contaminants to flow therethrough, a front side of said cartridge comprising an unobstructed opening through which said media block having substantially corresponding dimensions can be inserted.

13. The filter assembly of claim 12, further comprising at least one lance element extending forward from an interior rear wall of said cartridge, toward said opening, said lance element configured to penetrate said media block when fully inserted within said cartridge through said opening.

14. The filter assembly of claim 13, further comprising said media block received within said cartridge, said media block comprising fibrous batting that has been impregnated with species effective adsorb contaminants in an airstream flowing therethrough.

15. The filter assembly of claim 14, further comprising a reinforcing cover layer laminated to said media block, said cover layer having greater dimensional integrity than said media block and comprising at least one cutout through which said lance element penetrates the media block.

16. The filter assembly of claim 14, further comprising at least one reinforcing strip adhered to said media block, said reinforcing strip having greater rigidity than said media block and comprising at least one cutout through which said lance element penetrates the media block.

17. The filter assembly of claim 14, further comprising a reinforcing cage substantially enclosing said media block, said cage comprising at least one cutout through which said lance element penetrates the media block.

18. A filter assembly for a cooking appliance, comprising a media block and at least one reinforcing element attached to said media block, the reinforcing element having greater dimensional stability than the media block, at least one cutout provided in the reinforcing element configured to receive a lance element therethrough.

19. The filter assembly of claim 18, said reinforcing element comprising a reinforcing fabric layer laminated to the media block.

20. The filter assembly of claim 18, said reinforcing element comprising at least one reinforcing strip adhered to said media block, said reinforcing strip made of at least one of paper, plastic and metal.

21. The filter assembly of claim 18, said reinforcing element comprising a reinforcing cage substantially enclosing said media block, said cage made of at least one of paper, plastic and metal.
